(19) United States
(12) Patent Application Publication
(10) Pub. No.: US 2006/0138719 A1
(43) Pub. Date: Jun. 29, 2006

(54) Hydraulic antivibration device with a spacer

(75) Inventors: Jean-Claude Petit, Chateaudun (FR); David Meunier, Chateaudun (FR); Christophe Roquain, Ecorpain (FR)

Correspondence Address: MILLER, MATTHIS & HULL, ONE NORTH FRANKLIN STREET, SUITE 2350, CHICAGO, IL, 60606, US

(73) Assignee: Hutchinson, Paris (FR)

(21) Appl. No.: 11/288,950

(22) Filed: Nov. 29, 2005

(30) Foreign Application Priority Data
Dec. 9, 2004 (FR) 0413140

(51) Int. Cl. F16F 13/00

(52) U.S. Cl. 267/140.4; 267/140.13

(57) ABSTRACT

A hydraulic antivibration device comprising: two rigid strength members, a working chamber and a compensation chamber communicating with each other via a constricted passage, a decoupling flap being disposed between the two chambers, the flap being movable over a short stroke, at least one perforated rigid partition separating the two chambers, said partition being closed by the flap, the flap being in the form of a plate of elastically deformable material, and being disposed in an opening in a spacer clamped between two plane parallel grids disposed respectively in the working chamber and in the compensation chamber, the stroke of the flap between the grids being defined by the thickness of the spacer.

### FIELD OF THE INVENTION

The present invention relates to hydraulic antivibration devices for interposing for damping and connection purposes between two rigid elements such as, in particular, the chassis and the engine of a vehicle.

Amongst such devices, the invention relates more particularly to those comprising two strength members, with an elastomer body interconnecting the two strength members, and further comprising:

a working chamber defined at least in part by the elastomer body;

a compensation chamber;

a constricted passage putting the two chambers into communication with each other, the two chambers and the passage being filled with liquid;

a decoupling flap disposed between the two chambers, said flap being movable over a short stroke, typically parallel to the central axis of the device; and

a perforated rigid partition separating the two chambers and closed by the flap.

### BACKGROUND OF THE INVENTION

As is known, with such a device, vibration at high frequency and low amplitude, such as the vibration due to the engine idling, leads to a rapid succession of alternating deformations of the flap perpendicularly to itself, and suitable for attenuating the transmission of the vibration in question.

In contrast, for oscillations of larger amplitude and lower frequency, such as those due to irregularities and variations in the slope of the ground (“choppiness”) while the vehicle is traveling over the ground, the amplitude of the deformation of the flap reaches its maximum possible value and the liquid is driven from one of the two chambers to the other and back again through the constricted passage, with the mass of liquid that is driven in this way being set into resonance when the frequency of the oscillations reaches a predetermined value that is a function of the ratio between the axial length and the right section of the constricted passage.

Thus, the constricted passage enables liquid to be transferred between the two chambers to provide hydraulic damping of axial movements at low frequency (e.g. less than 20 hertz (Hz)) and of large amplitude (e.g. greater than 0.5 millimeters (mm)).

The decoupling flap serves to absorb axial vibration of relatively high frequency (e.g. greater than 20 Hz), and small amplitude (e.g. less than 0.5 mm).

One such hydraulic antivibration device is disclosed in document FR-2 751 042, for example. The rigid partition therein is horizontal, made of metal, and subdivides the case into a working chamber beside an elastomer body that is bell-shaped, and a compensation chamber beside a bellows. In that prior embodiment, the flap is formed by an elastomer plate mounted with little clearance between two parallel grids of the intermediate partition. The constricted channel is defined by a rigid shell in the form of an aluminum casting, or by a molded piece of plastics material, and the assembly formed by the two metal grids and the rigid cast aluminum shell is held together by crimping.

Manufacturing the partition elements of prior art devices is found to be expensive: the perforated grids must be as plane and parallel as possible and they must be spaced apart by a predetermined distance so that the movement of the flap is effective in attenuating vibration.

Some engines, in particular so-called “low vibration” engines, require decoupling clearance that is accurate and small, and they thus require accurate control over the spacing and the planeness of the perforated disks, with expensive aluminum alloy components being conventionally used for such purposes.

However ensuring that the cast alloy grids are plane is difficult because the grids are punched and because they shrink, in particular when the grids are made of aluminum alloy.

### OBJECTS AND SUMMARY OF THE INVENTION

The Applicant has sought to solve the above problems by proposing a structure that is also easy to assemble.

To this end, in a first aspect, the invention provides a hydraulic antivibration device for interposing between two elements, the device comprising two rigid strength members suitable for fastening respectively to two rigid elements that are to be united, the device including a working chamber and a compensation chamber, a constricted passage putting the two chambers into communication with each other, the two chambers and the passage being filled with liquid, the device including a decoupling flap disposed between the two chambers, said flap being movable over a short stroke, typically parallel to the central axis of the device, at least one perforated rigid partition separating the two chambers, said partition being closed by the flap, the flap being in the form of a plate of elastically deformable material disposed in an opening in a spacer clamped between first and second grids, the two grids being plane and parallel and disposed respectively in the working chamber and the compensation chamber, the stroke available for the flap between the grids being defined by the thickness of the spacer.

In various embodiments, the device presents the following features, possibly in combination:

the constricted passage putting the working chamber and the compensation chamber permanently into communication is formed by a channel made integrally with the spacer;

the channel extends substantially perpendicularly on either side of the mean plane of the spacer plate;

the two perforated grids are substantially identical in shape and dimensions;

the flap is generally in the form of a plane disk; and

the flap is provided with projections projecting from at least one of its two faces.

In a particular embodiment, the spacer is made integrally with one of the two perforated grids. Assembly is thus made easier by hot or cold deformation.

In another embodiment, the two perforated grids are made out of stamped sheet metal, the spacer being made of a polymer material, and the flap being made of elastomer.

Compared with components made of cast aluminum, which are relatively expensive, stamped steel sheet also offers the advantage of better control over planeness.

In another embodiment, the assembly formed by the grids, the spacer, and the flap is assembled by implementing at least one of the following methods: clip-fastening; sheet-metal-to-sheet-metal assembly; hot deformation; cold deformation; plastic deformation.

### BRIEF DESCRIPTION OF THE DRAWINGS

Other objects and advantages of the invention appear from the following description of embodiments, which description is given with reference to the accompanying drawing, in which:

FIG. 1 is a face view of an assembly in an embodiment of the invention, shown in the assembled configuration; and

FIG. 2 is an exploded perspective view of the parts making up the assembly shown in FIG. 1.

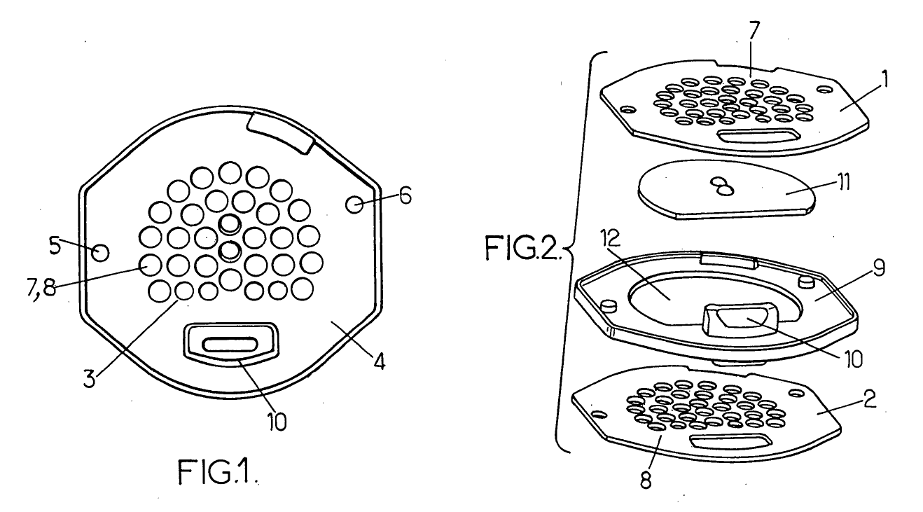

### MORE DETAILED DESCRIPTION

In the description below, terms such as “up”, “down”, “bottom”, “top”, “vertical”, “horizontal”, are used solely for the purpose of making the description simpler and clearer, and they are with reference to the normal position of use of the device of the invention, however these terms are not limiting.

The decoupling assembly of the hydraulic antivibration device shown in the figures has two grids 1, 2, e.g. made of metal alloy such as steel. These two grids may be identical, i.e. a top horizontal grid 1 and a bottom horizontal grid 2.

In one embodiment, these grids 1 and 2 are of substantially constant thickness and each includes a perforated central portion 3 and a solid peripheral portion 4 having fastening orifices 5, 6 and through holes 7, 8 for passing fluid.

The decoupling assembly also comprises a spacer 9 of polymer material.

In the embodiment shown, the spacer is provided with a channel 10 forming a constricted passage for the fluid between the working chamber and the compensation chamber.

The dimensions of the channel 10 may be adapted to have a resonant frequency of about 10 Hz to 20 Hz, so as to enable the choppy movements due to the vehicle running to be damped, or else a resonant frequency adapted to damping vibration due to the vehicle engine idling. In one embodiment, the channel is made integrally with the body of the spacer. It extends substantially perpendicularly on either side of the spacer.

The two perforated grids 1 and 2 are of substantially identical shape and dimensions, with this disposition being advantageous in terms of manufacturing costs and quality control.

The flap 11 housed in the opening 12 in the spacer is generally in the form of a plane disk.

In certain embodiments, the flap is provided with bulges projecting from at least one of its two faces.

In a particular embodiment, the spacer is made integrally with one of the two perforated grids. The grids and the spacer can thus be assembled together by hot or cold deformation.

In another embodiment, the two perforated grids 1 and 2 are made of stamped sheet metal, the spacer being made of a polymer material, and the flap 11 being made of elastomer.

Compared with components made of cast aluminum alloy, which are relatively expensive, stamped steel sheet also offers the advantage of better control over planeness.

In another embodiment, the assembly formed by the grids, the spacer, and the flap is assembled by making use of at least one of the following methods: clip-fastening, sheet-metal-to-sheet-metal assembly, hot deformation, cold deformation, plastic deformation.

The invention as described above relates to antivibration supports of the two-mode or active type. It is particularly applicable to supporting low-vibration engines that require precise decoupling clearance. The assembly also makes it less expensive to integrate an idling column.

What is claimed is:

1. A hydraulic antivibration device for interposing between two elements, the device comprising two rigid strength members suitable for fastening respectively to two rigid elements that are to be united, the device including a working chamber and a compensation chamber, a constricted passage putting the two chambers into communication with each, the two chambers and the passage being filled with liquid, the device including a decoupling flap disposed between the two chambers, said flap being movable over a short stroke, at least one perforated rigid partition separating the two chambers, said partition being closed by the flap, the flap being in the form of a plate of elastically deformable material, wherein the flap is disposed in an opening in a spacer clamped between first and second grids, the two grids being plane and parallel and disposed respectively in the working chamber and the compensation chamber, the stroke available for the flap between the grids being defined by the thickness of the spacer, the constricted passage putting the working chamber and the compensation chamber permanently into communication being constituted by a channel made integrally with the spacer.

2. An antivibration device according to claim 1, wherein the channel extends substantially perpendicularly on either side of the mean plane of the spacer plate.

3. An antivibration device according to claim 1, wherein the two perforated grids are substantially identical in shape and dimensions.

4. An antivibration device according to claim 1, wherein the flap is generally in the form of a plane disk.

5. An antivibration device according to claim 1, wherein the flap is provided with projections projecting from at least one of its two faces.

6. An antivibration device according to claim 1, wherein the spacer is made integrally with one of the two perforated grids.

7. An antivibration device according to claim 1, wherein the two perforated grids are made out of stamped sheet metal, the spacer being made of a polymer material, and the flap being made of elastomer.

8. An antivibration device according to claim 1, wherein the assembly formed by the grids, the spacer, and the flap is assembled by implementing at least one of the following methods: clip-fastening; sheet-metal-to-sheet-metal assembly; hot deformation; cold deformation; plastic deformation.
